(19) United States
(12) Patent Application Publication
(10) Pub. No.: US 2016/0288871 A1
(43) Pub. Date: Oct. 6, 2016

(54) BICYCLE WITH FRONT AND REAR DRIVES WITH REPOSITIONED CRANKS, EXTENDED PEDAL LEVERS DRIVE

(71) Applicant: Isagani C. Atil, Panorama City, CA (US)

(72) Inventor: Isagani C. Atil, Panorama City, CA (US)

(21) Appl. No.: 14/674,289

(22) Filed: Mar. 31, 2015

(51) Int. Cl. B62M 1/14; B62M 1/26; B62M 1/12

(52) U.S. Cl. CPC B62M 1/14; B62M 1/12; B62M 1/26

(57) ABSTRACT

Improvements in a bicycle with four wheel drive. The front wheel drive uses arm and forearm powered system for a steerable bicycle that allows bikers to also exercise arm and forearm muscles. The drive incorporates lever fulcra located forward of the main handle bar. The main lever serves as handle grip at one end. The lever arm's length extends to the fulcrum. The rear wheel drive uses a sectorial pedal arc motion and reduces the number of leg muscles to propel the bicycle. The lever arms extend from the pedal foot pads at one end, to the fulcra located at the rear and lower (3rd) quadrant at the back of the rear wheel. The pedals rest higher above the road surface and allows a biker to negotiate over highly irregular or rough, uneven terrain with reduced possibility of pedals or rider's feet hitting ground objects.

### CROSS REFERENCE TO RELATED APPLICATIONS

This application is a continuation-in-part of applicant's co-pending application Ser. No. 62/090,720 filed Dec. 11, 2014 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a bicycle drive system. More particularly, the present bicycle drive system is for a bicycle with front and rear drives with repositioned cranks, extended pedal levers and drive.

Description of Related Art including information disclosed under 37 CFR 1.97 and 1.98.

Bicycles are used in most parts of the world for transportation. The present bicycle has had only minor changes over the last half-century. While there have been variations for recumbent bicycles, the basic power transmission using a rotating pair of pedals that are connected with an endless chain with sprockets on the crank and on the driven wheel.

A number of patents and or publications have been made to address these issues. Exemplary examples of patents and or publication that try to address this/these problem(s) are identified and discussed below.

U.S. Pat. No. 326,247 issued on Sep. 15, 1885 to J. B. Root discloses an Exercising Machine. The exercising machine allows a person to pump the arms with feet and or legs. While this patent discloses a pumping exercise machine the machine does not translate the exercise into forward motion.

U.S. Pat. No. 4,147,370 issued on Apr. 3, 1979 to Ben Lindsey, Jr discloses a Front Wheel Drive for a Bicycle. The drive system is a single stroke arm for turning the front wheel of the bicycle. While it converts a pumping motion to turn the front wheel, both arms must operate with the same forward and backward motion, it does not allow for alternate pumping of the arms of a user.

U.S. Pat. No. 4,421,334 issued on Dec. 20, 1983 to Boris Efros discloses a High Speed Cycle and U.S. Pat. No. 6,578,861 issued on Jun. 17, 2003 to Jun-Shin Park discloses a Reciprocating Type Driven Mechanism. Both of these allow for a pumping motion of the feet to provide propulsion of the bicycle. While they allow pumping to propel the bicycle they do not provide separate propulsion for the front and the back wheels.

What is needed is a bicycle design with economy of motion. Since it only requires virtual up and down motion of the pedals. It also delivers added vertical length to the rider's overall pedal motion. The design disclosed in this document is for a bicycle with more pedal structural and motion stability. Since it is attached at both ends of the drive lever system. The side sway problem with long levers can be stabilized with this design.

### BRIEF SUMMARY OF THE INVENTION

It is an object of the bicycle drive system to deliver greater propulsion advantage than ordinary rear wheel driven bicycle. Traction on the front wheel minimizes skids over wet or muddy surfaces. Since the generated force is pulling instead of pushing, it delivers a higher degree of efficiency in propulsion and maneuverability overall.

It is an object of the bicycle drive system for economy of motion. The cyclist pedals only in up and down motion to propel the bicycle. Less muscles are involved in the process hence less tiresome. This action translates to farther distances and more hours logged between rests. Cramps or fatigue is greatly diminished.

It is an object of the bicycle drive system to utilize longer lever arms, it generates more power than what present day cyclist could deliver. This is because this type of design with extended cranks produces a force multiplier effect. A total output force of three times or more over the initial input force is therefore attainable. Meaning speed or load pulling capacities can be much higher than present day bicycle capabilities. With pedals resting higher above road surface, it allows biker to negotiate over highly irregular or rough, uneven terrain with reduced possibility of pedals or rider's feet hitting ground objects that may cause injuries. Riding through streams or water logged areas within reasonable depth allowances, and over adequate surface load bearing capacities, can be possible.

It is an object of the bicycle drive system to generate more efficient utilization of mechanical forces properly applied for the riders' comfort and benefit. This results in generating more speed and power over the existing bicycle designs with its long crank lever force multiplier design.

Claim 1 It is an object of the bicycle drive system to be a safer ride with crank pedals and feet higher above surface grade. Therefore the chance of hitting surface objects resulting in injuries is reduced.
Claim 2 It is an object of the bicycle drive system for the bicycle to allow physically weaker person to ride since it requires lesser physical effort to propel it.
Claim 3 It is another object of the bicycle drive system to reduce accidents or injuries resulting from skids or unstable ride characteristics such as wobbles resulting from wet or muddy road conditions. This front drive attains to some degree added stability on areas that ordinary bicycles may not be capable of performing.
Claim 4 It is still another object of the bicycle drive system for the drive system to be installed with a battery that can be fitted with led headlamps, brake lights, hazard lights and turning lights. Thus enhancing more safety factors for the biker and the public as well. With the bicycles added force output a small alternator can be attached to the rear wheel to charge the battery installed on the bike. Thus reducing dependence on household current and contributing to renewable green energy solutions.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a bicycle front drive parts and mechanism design.

FIG. 2A-2C shows drawings of models with front manual drives.

FIGS. 3A and 3B shows series a—isometric and side view drawings respectively.

FIGS. 4A and 4B shows series a—rear drive parts and mechanism design drawings respectively.

FIGS. 5A and 5B shows series b—isometric and side view drawings respectively.

FIGS. 6A and 6B shows series b—bicycle rear drive parts and mechanism design drawings respectively.

FIGS. 7A and 7B shows series c—isometric and side view drawings respectively.

FIGS. 8A and 8B shows series c—rear drive parts and mechanism design drawings respectively.

FIGS. 9A and 9B shows a front wheel and all wheel pedal drive side view drawings respectively.

FIG. 10 shows a front drive pedal bicycle side view drawing.

FIG. 11 shows a frame and mechanical front drive pedal bicycle side view.

FIG. 12 shows a front drive pedal bicycle frame and mechanical—exploded view.

FIG. 13 shows a front drive pedal bicycle 3-bar linkage mechanism drawing.

FIG. 14 shows an all-wheel drive pedal bicycle side view drawing.

FIG. 15 shows an all-wheel drive frame and mechanical parts arrangement exploded view.

FIG. 16A-16D shows a force multiplier design schematic of a force multiplier design drawing.

FIG. 17 shows a complementary motion force multiplier exploded view of a force multiplier design.

FIG. 18 shows a sprocket and ratchet crank assembly with slack compensator drawing for the force multiplier design.

### DETAILED DESCRIPTION OF THE INVENTION

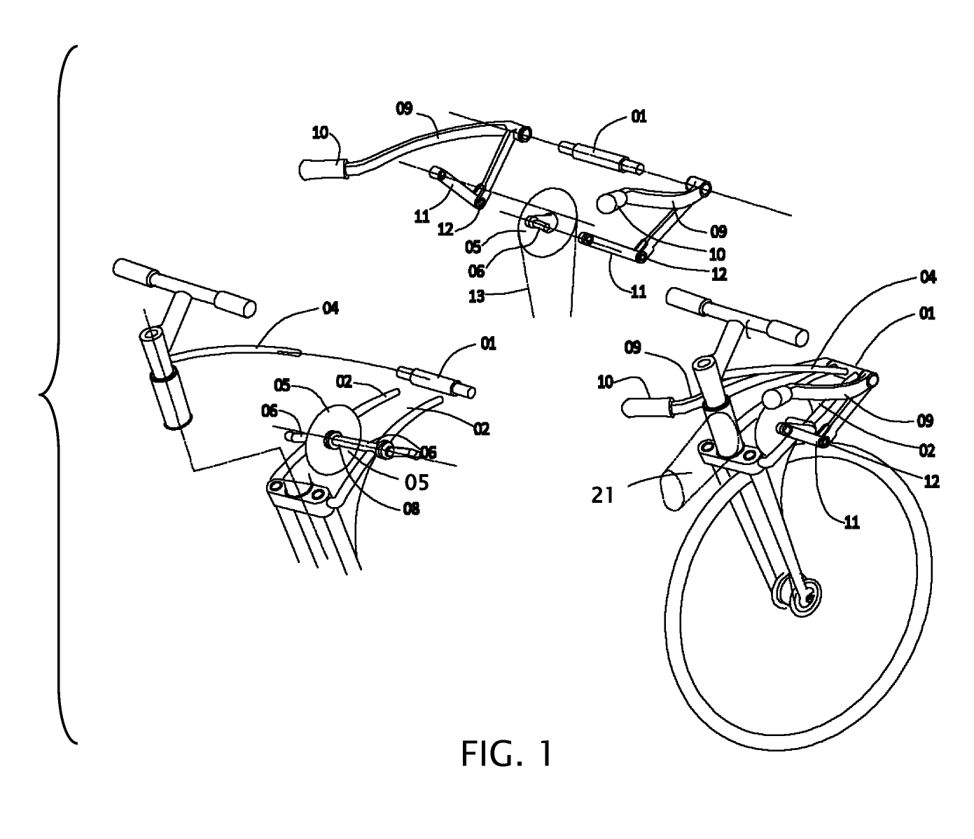

FIG. 1 shows a bicycle 21 front drive parts and mechanism design. This figure shows the pivot bar 01 with arms 09 having hand grips 10. At the other end of the arms are joints 12 that connect with linkage arms 11. The linkage arms 11 are connected to pivots 06 on crank 05 with supporting fastener 08 where the chain 13 or other flexible transmission medium is connected. The crank 05 is supported with members 02 from the frame that extend from the forks of the bicycle. Fore post 04 provides front support and support for steering the front wheel.

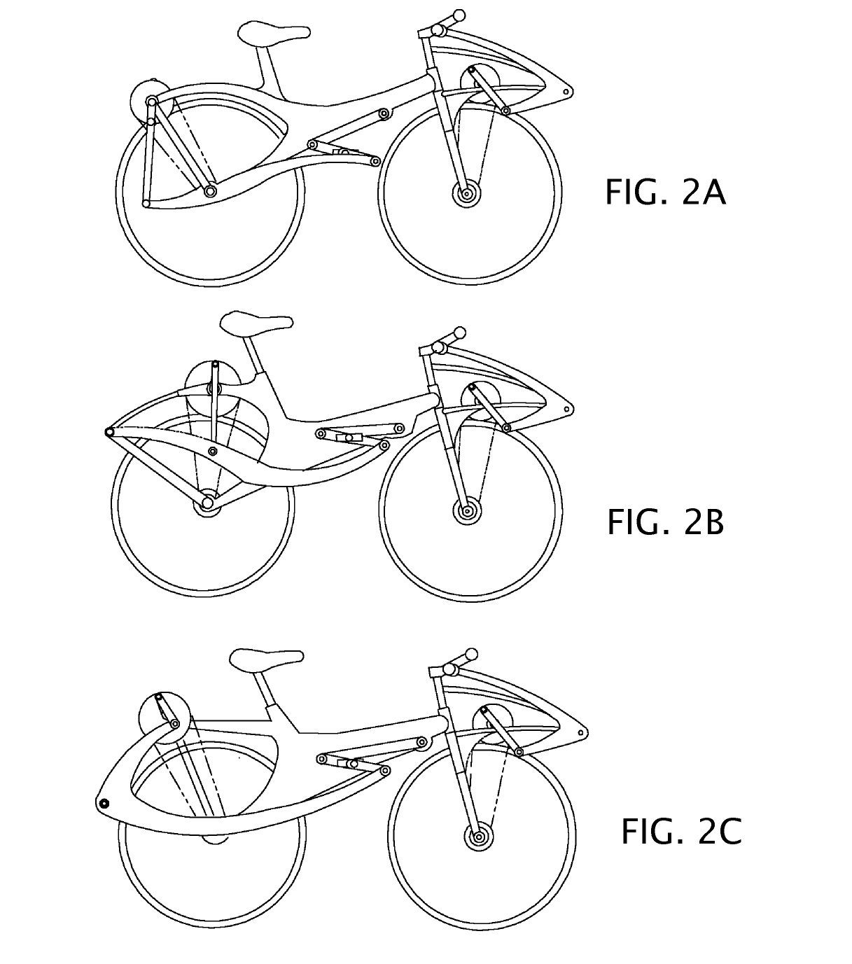

FIG. 2A-2C shows drawings of models with front manual drives. FIG. 2A shows a Series a embodiment bicycle with front manual drive, with rear pedal drive. This Class 1 lever type bicycle has a medium length rear drive lever with rear and front sprockets, with vertical path pedal strokes. It provides a stable and smooth pedal motion and optionally can have a force multiplier.

FIG. 2B is a Series b embodiment bicycle with front manual drive, with rear pedal drive. This Class 2 lever type bicycle has a long rear drive lever with rear and front sprockets, with vertical path pedal strokes. It provides a stable and smooth pedal motion and optionally can have a force multiplier.

FIG. 2C is a Series c embodiment bicycle with manual front manual drive, with rear pedal drive. This Class 1 long length rear drive lever with rear and front sprockets, with vertical path pedal strokes. It provides a stable and smooth pedal motion and optionally can have a force multiplier.

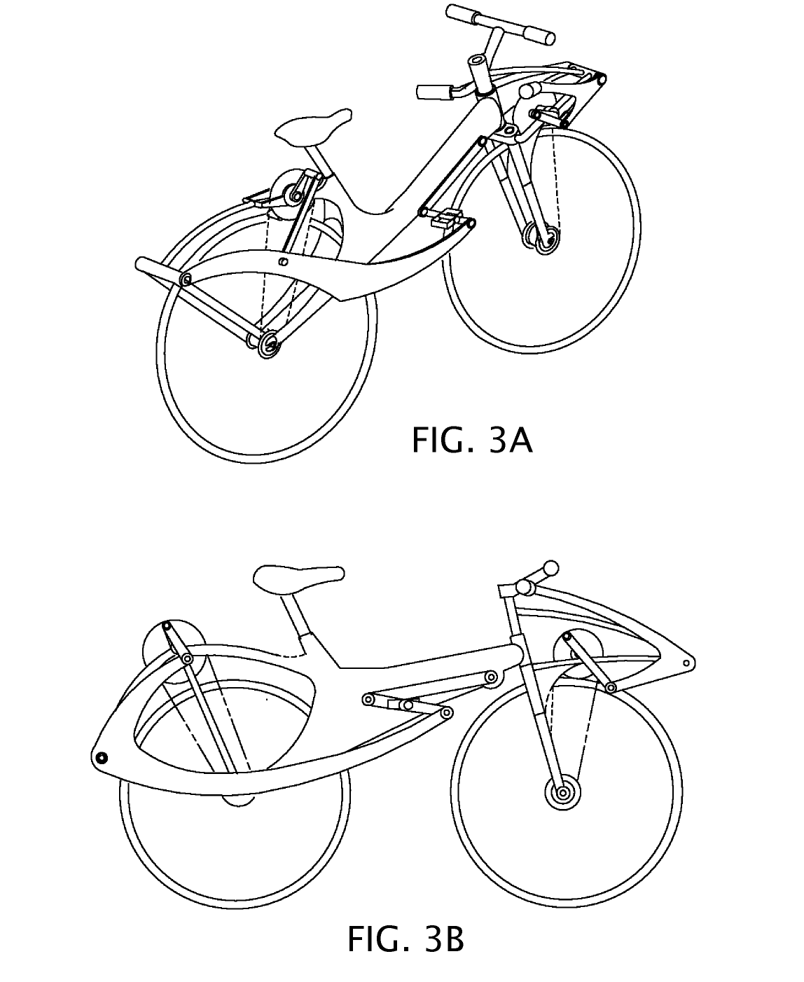

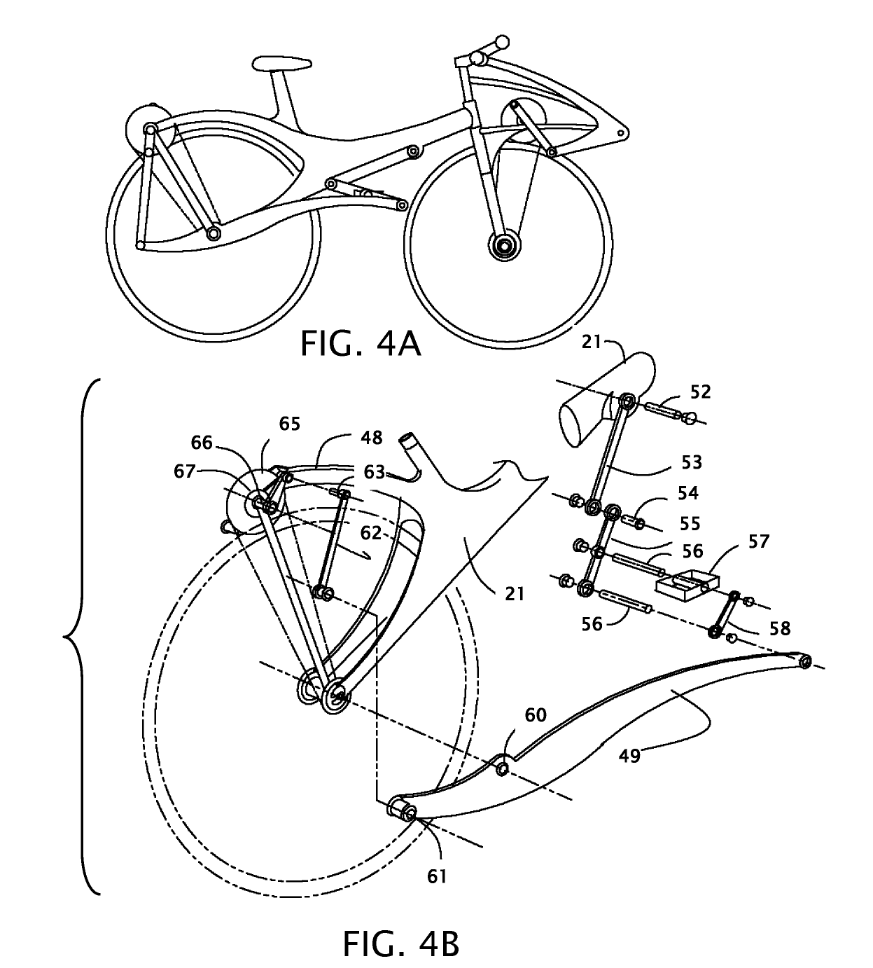

FIGS. 3A and 3B shows series a—isometric and side view drawings respectively and FIGS. 4A and 4B shows series a—rear drive parts and mechanism design drawings respectively. These figures show the Series a embodiment bicycle from FIG. 2A with front manual drive, with rear pedal drive. This Class 1 lever type bicycle has a medium length rear drive lever with rear and front sprockets, with vertical path pedal strokes. It provides a stable and smooth pedal motion and optionally can have a force multiplier.

Front Drive

The new arm and forearm-powered front drive on this steerable, stable bicycle, creates the opportunity for bikers to add arm and forearm muscles to develop physical fitness, in addition to the bicycle's usual common uses. It generates more power output to the total bicycle propulsion with the added power generated by both arms. This is made possible by a set of levers whose fulcra are located at points forward of the main handle bar. The main lever serves as handle grip at one end. This lever arm's length extends to the fulcrum.

Attached to the main lever arm at about the fulcrum is the angled leg or extension of the main lever whose fixed length and angle is determined by the length of the linkage bar that is attached to the bicycle crank arm, also located with bar supports forward of main handle bar. The usual standard chain crank and sprockets drive, fork frame and wheel make up the rest of the front drive. an optional hood over and foil under the front crank with spoilers on the sides of the lever arms could at certain speeds reduce drag resistance created by the rider's upper body and arms.

In FIG. 4B the traditional foot type pedal 57 is connected through pivots 56 to a crank arm 55. This crank arm 55 is connected through pivot pin 54 to arm 53. The arm 53 is connected through pivot 52 to the frame 21 of the bicycle. The pivots 56 are also connected with joiner 58 to lever arm 49. The lever arm 49 connects through the wheel axle 60 and then to pivot 61 that connects to arm 62 and pivot 63. The other side of arm 62 connects to crank 66 on sprocket 65 of the turning axle 67. The sprocket 65 is supported on frame member 48.

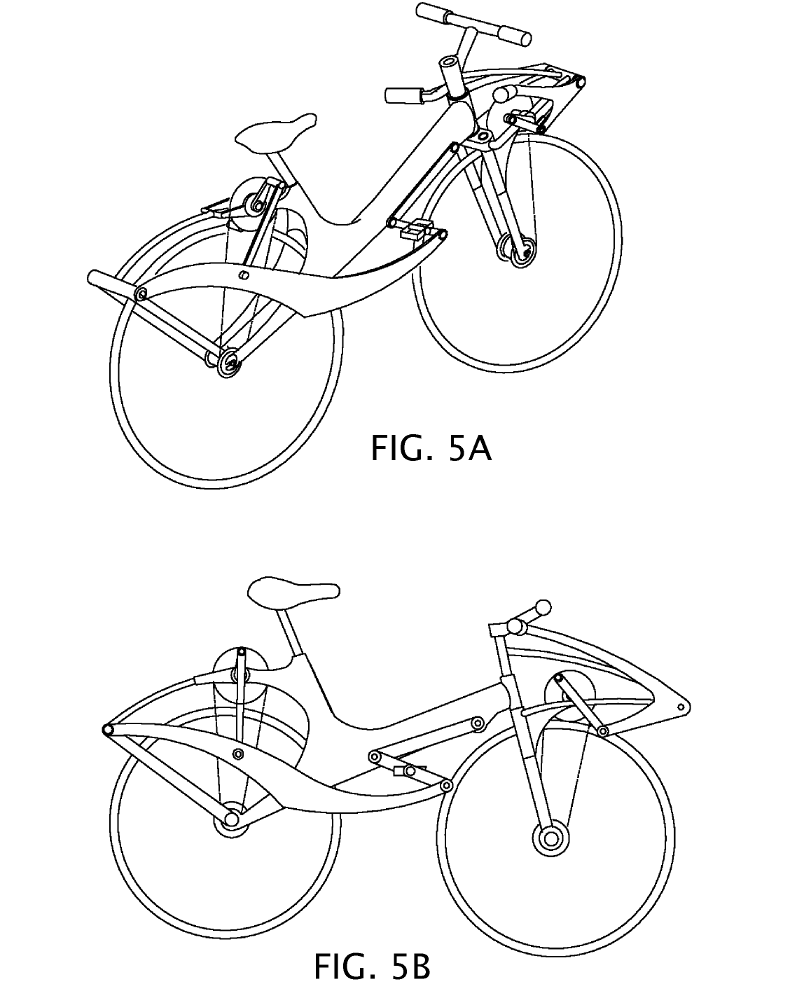

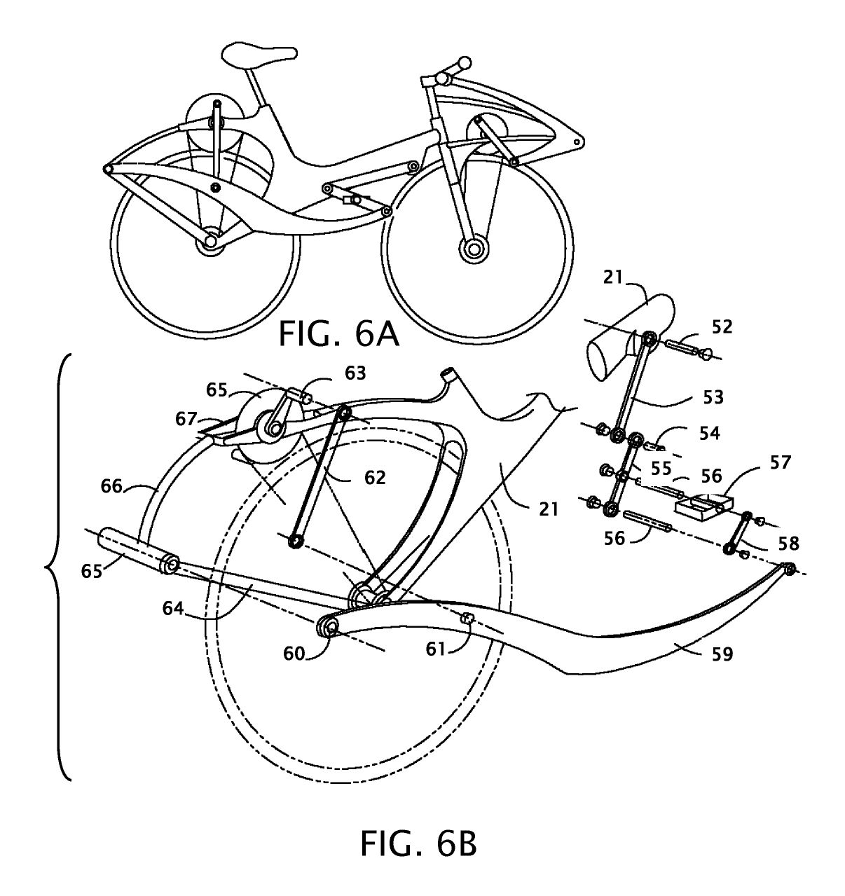

FIGS. 5A and 5B shows series b—isometric and side view drawings respectively and FIGS. 6A and 6B shows series b—bicycle rear drive parts and mechanism design drawings respectively. These figures show the Series B embodiment bicycle from FIG. 2B. This Class 2 lever type bicycle has a long rear drive lever with rear and front sprockets, with vertical path pedal strokes. It provides a stable and smooth pedal motion and optionally can have a force multiplier.

In FIG. 6B, the traditional foot type pedal 57 is connected through pivots 56 to a crank arm 55. This crank arm 55 is connected through pivot pin 54 to arm 53. The arm 53 is connected through pivot 52 to the frame 21 of the bicycle. The pivots 56 are also connected with joiner 58 to lever arm 59. The lever arm 59 connects through the wheel axle 60 and then to pivot 61 that connects to arm 62 and pivot 63. The other side of arm 62 connects to sprocket 65 of the turning axle 67. The sprocket 65 is supported on a frame member 66 and extends beyond the turning axis of the rear wheel with support 64.

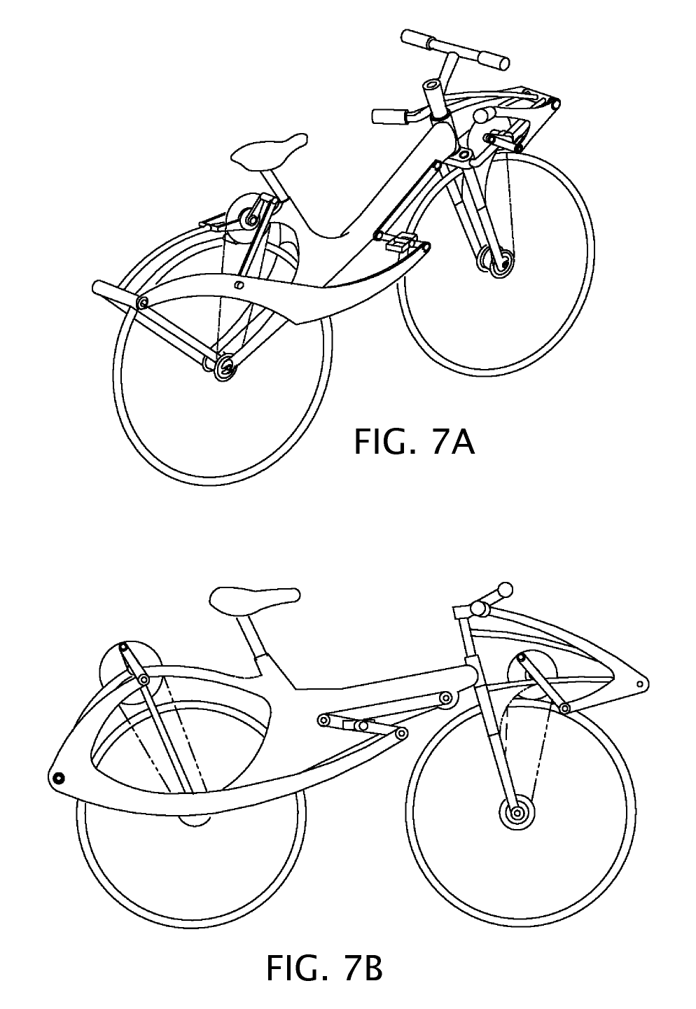

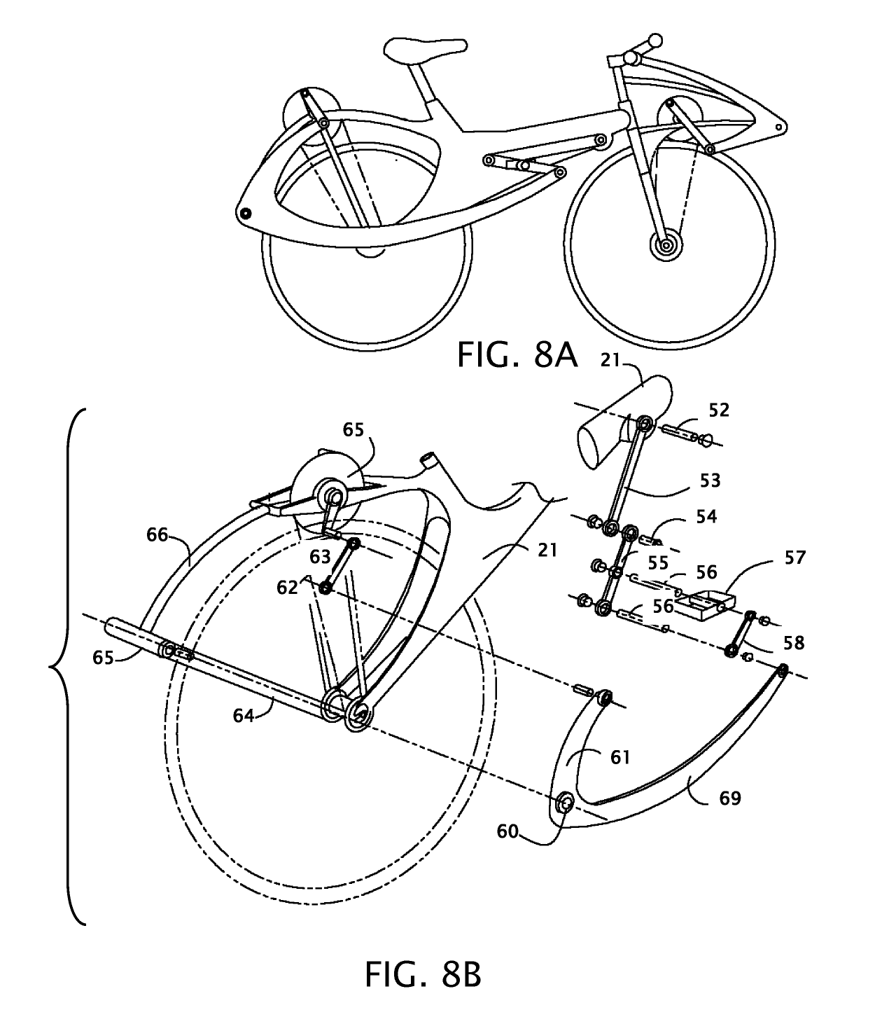

FIGS. 7A and 7B shows series c—isometric and side view drawings respectively and FIGS. 8A and 8B shows series c—rear drive parts and mechanism design drawings respectively. These figures show the Series c embodiment bicycle from FIG. 2C. This Class 1 long length rear drive lever with rear and front sprockets, with vertical path pedal strokes. It provides a stable and smooth pedal motion and optionally can have a force multiplier.

In FIG. 8B, the traditional foot type pedal 57 is connected through pivots 56 to a crank arm 55. This crank arm 55 is connected through pivot pin 54 to arm 53. The arm 53 is connected through pivot 52 to the frame 21 of the bicycle. The pivots 56 are also connected with joiner 58 to lever arm 59. The lever arm 59 connects through the wheel axle 60 and then to pivot 61 that connects to arm 62 and pivot 63. The other side of arm 62 connects to sprocket 65 of the turning axle. The sprocket 65 is supported on a frame member 66 and extends beyond the turning axis of the rear wheel with support 64.

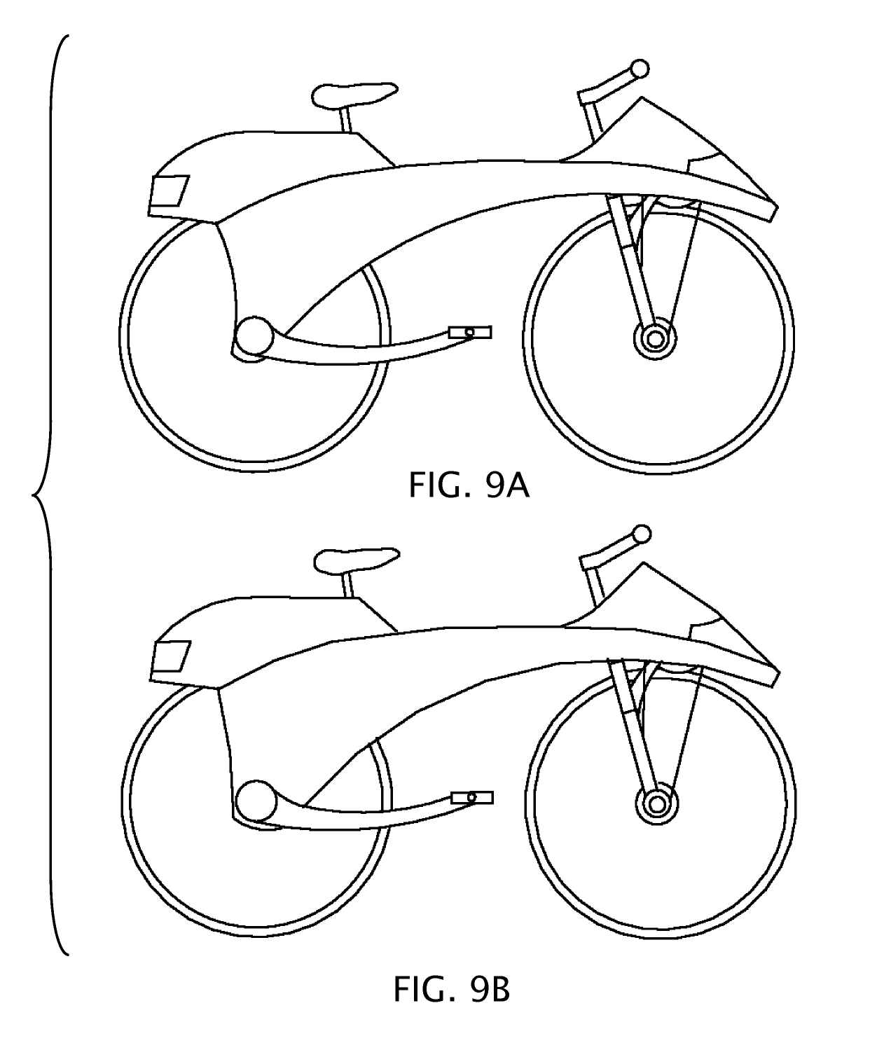

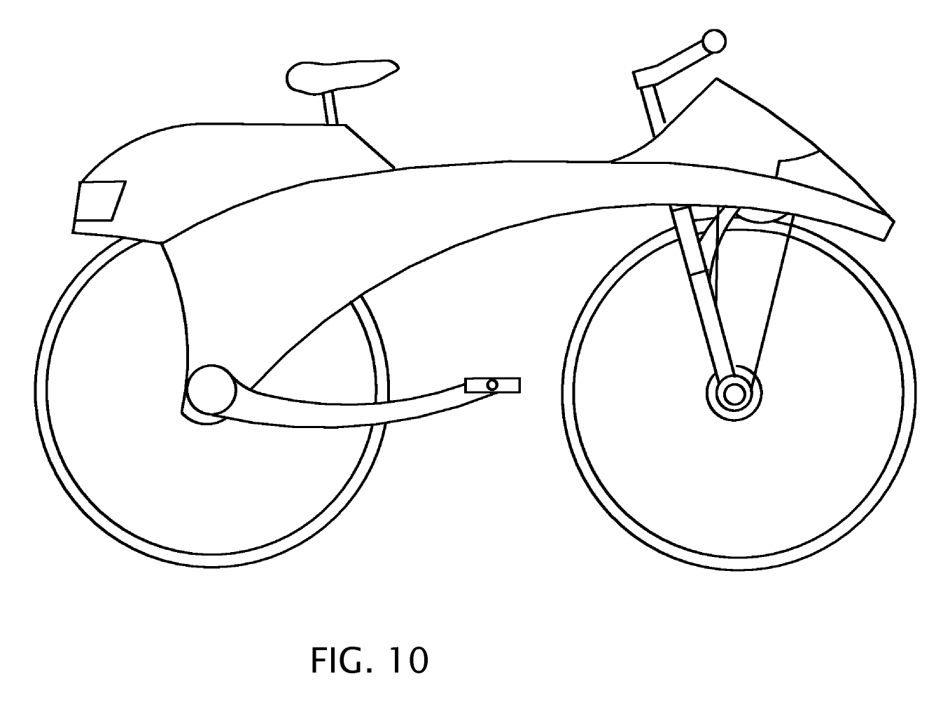

FIGS. 9A and 9B shows a front wheel and all wheel pedal drive side view drawings respectively and FIG. 10 shows a front drive pedal bicycle side view drawing. These front wheel drive pedal bicycles have a body shell cover that provides for safer operation of the power transmission elements by protecting them from a person's clothing.

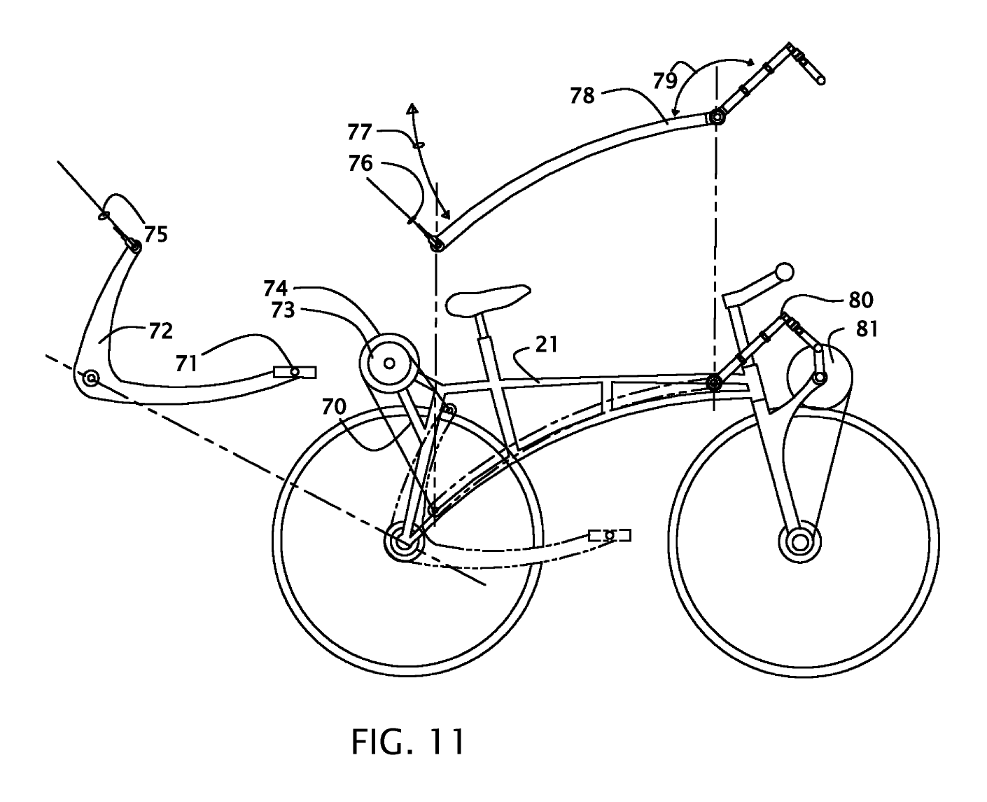

FIG. 11 shows a frame and mechanical front drive pedal bicycle side view. The frame 21 has a pulley support frame 70. The pulley support frame 70 supports a pedal 71 with a pedal arm 72 and a wire cable 75 that runs to a small diameter pulley. There is a wider diameter pulley 74 and a smaller diameter pulley 73. A wire cable 76 to a wider diameter pulley 76 operates on an arm swing arc 77 on the front drive arm assembly 78. The front drive arm 78 operates on a fixed angle 79. In the front of the bicycle is a 3 bar linkage mechanism 80 connected to a sprocket and crank assembly 81.

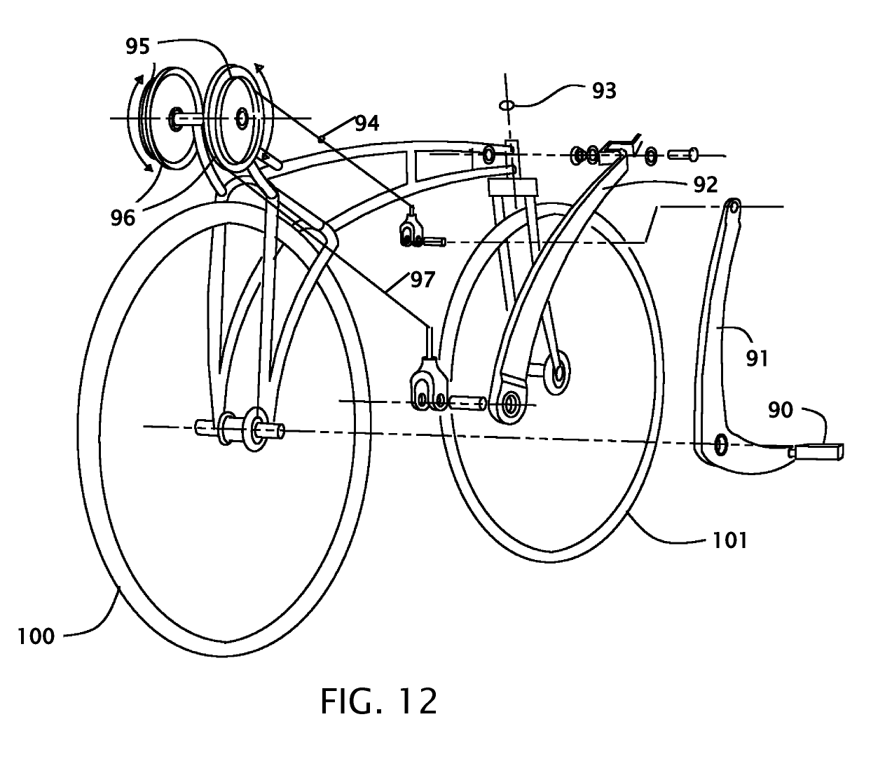

FIG. 12 shows a front drive pedal bicycle frame and mechanical—exploded view. In this view the bicycle is shown with a front wheel 101 and a rear wheel 100. Pedal 90 is connected to pedal arm 91 through a front drive arm 92. The front drive arm 92 connects with a wire cable to connect to a wider pulley to the front drive arm 97. The front drive has a wider diameter inner pulley 96 and a smaller diameter outer pulley 95. A wire cable 94 connects the smaller pulley to the pedal arm 91. The front steering handle bar post 93 is shown in this figure. The pulleys use roller clutches, sprag clutches or other one-way clutches to provide rotational power in one direction of rotation and free rotation in the opposite direction of rotation.

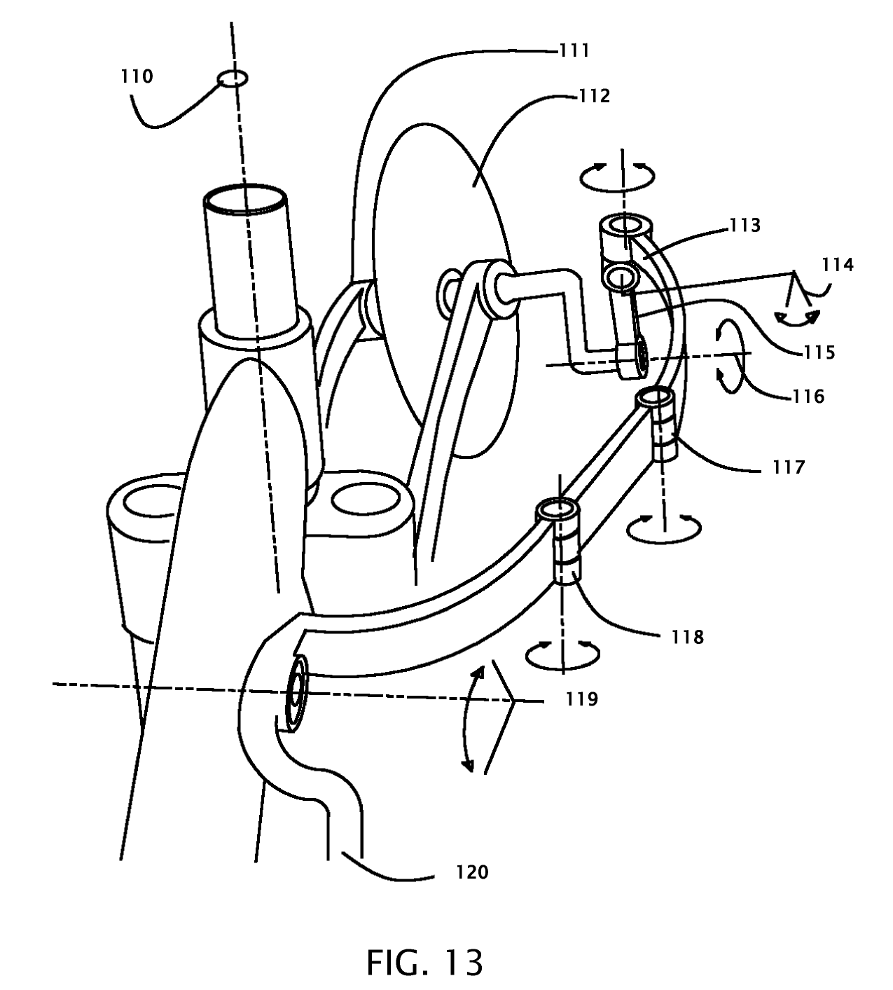

FIG. 13 shows a front drive pedal bicycle 3-bar linkage mechanism drawing. This figure shows the handle bar post 110 with the drive bar arm connected to the bicycle frame. Through a fulcrum anchor 119. There are two swivel links 117 and 118 that connect with connecting rod 115 through a bearing link 116 to provide a swivel link 114 with limited range of pivoting motion. There are 3 degrees of freedom in this link 113. The sprocket and crank 112 is shown with sprocket and crank supports 111.

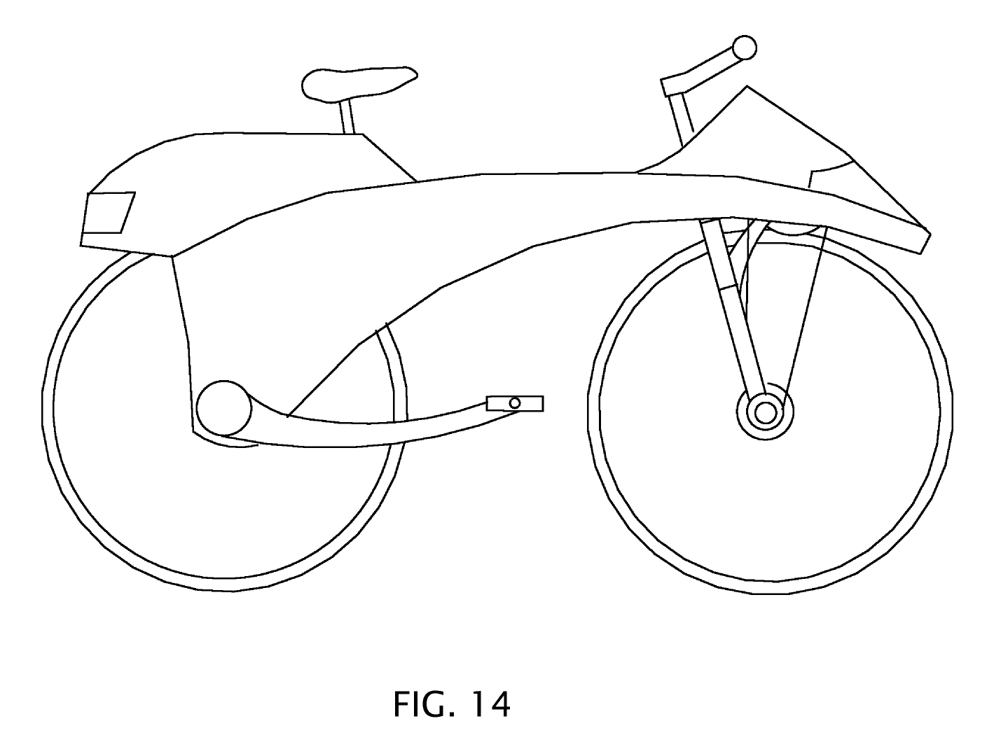

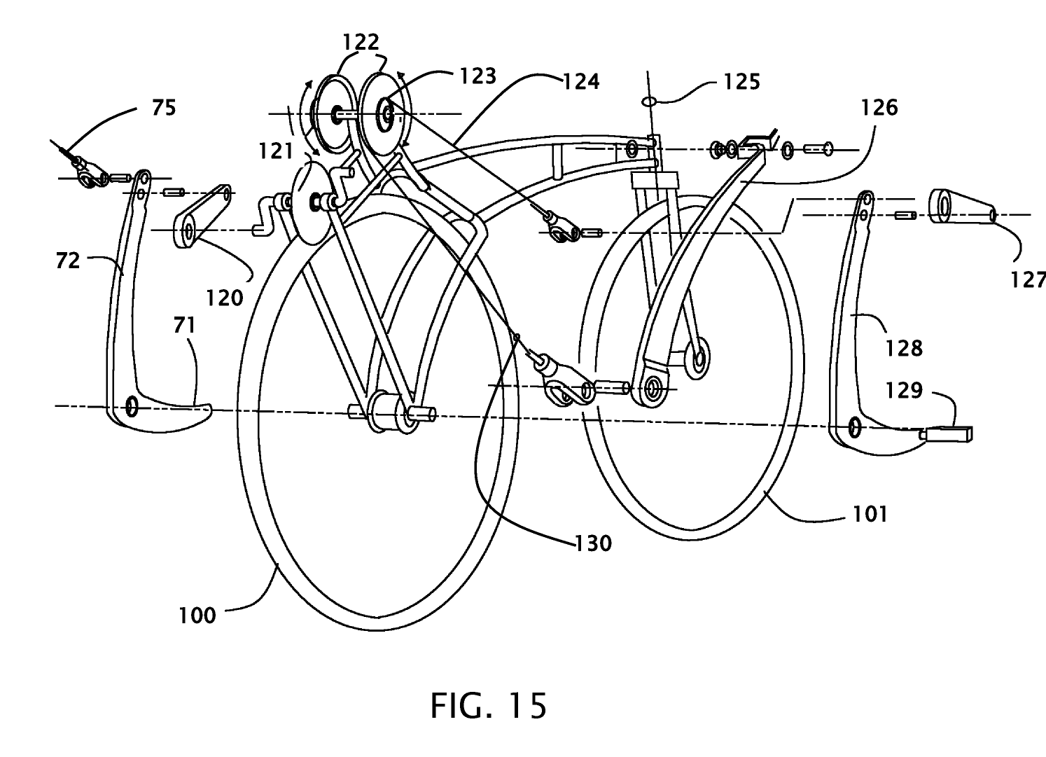

FIG. 14 shows an all-wheel drive pedal bicycle side view drawing and FIG. 15 shows an all-wheel drive frame and mechanical parts arrangement exploded view with the front wheel 101 and the rear wheel 100 connected to the drive mechanism(s). The rear wheel shows the pedal 71 connected to pedal arm 72. A connecting rod 120 connects between crank arm on the rear sprocket and crank assembly 121 and a wire cable 75 to connect a smaller pulley to the pedal arm 72. There is a wider diameter inner pulley 122 connected to a smaller diameter outer pulley 123. A wire cable 130 connects the wider pulley to the front drive arm. A wire cable 124 connects to the smaller diameter outer pulley 123. The handle bar post 125 is shown connected to steer the front wheel. A front drive arm 128 has a connecting rod 127 on one end and a pedal 125 connected at the other end. Cables (not shown) on opposite sides of the bicycle frame enters on opposite side of the pulleys 122 and 123.

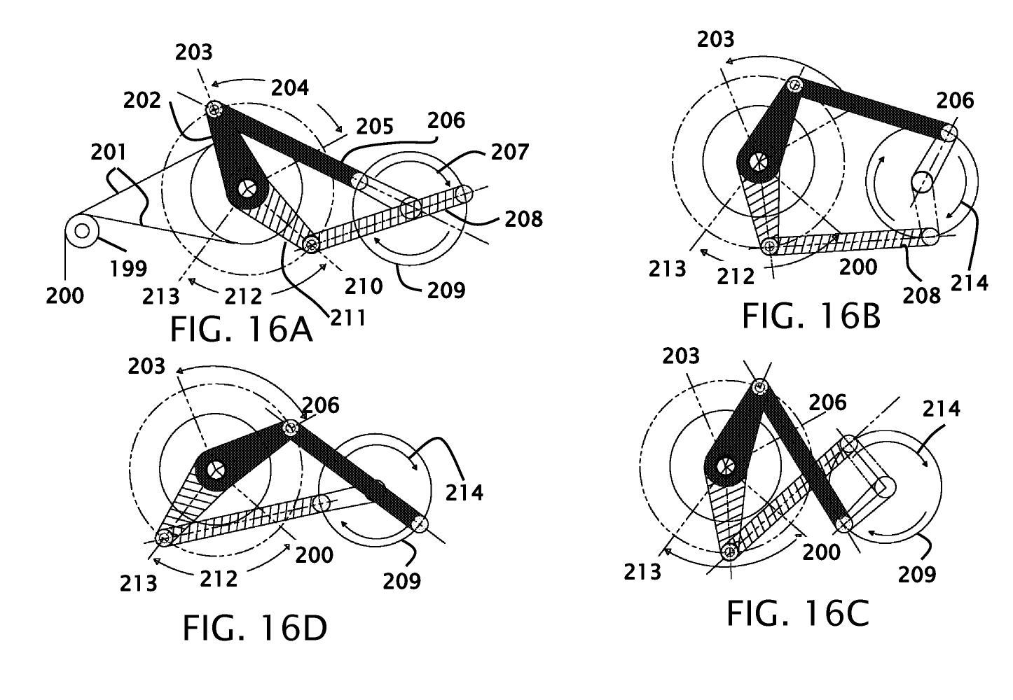

FIGS. 16 A-16C shows a force multiplier design schematic of a force multiplier design drawing. The force multiplier design has a start 203 and an end 205 position. The force multiplier uses a cable 200 is attached to pulley arms. The cable 200 connects to pulleys 199 with steel cable 201. A crank arm 202 rotates 204 between the start 203 and the end 205 rotation positions. A connecting rod connects to a sprocket and crank assembly 209. The result and synchronous rotational motion 207 is imparted onto the connecting rod on the opposite side 208 of the bicycle sprocket 209. This motion moves the swing arm 211 from a start position 210 to an end position 213 through a sectorial swing arc motion 212. This motion results on a continuous rotational motion 214.

FIG. 16A is the initial swing position, FIG. 16B is the middle forward swing position, FIG. 16C is the middle backswing position and FIG. 16D is the terminal swing position. Two counter swinging arms result into two complementing rotational motion components. The initial input force resulting to about twice the resultant rotational force delivered to the bicycle sprocket and crank assembly.

Rear Drive

The new vertical, sectorial pedal arc motion reduces the number of leg muscles involved to propel this bicycle as compared to the conventional rotational crank motion of present bicycle mechanism. It is made possible by long lever arms that extend from the pedal foot pads at one end, to the fulcra located at the rear and lower (3rd) quadrant at the back of the rear wheel. The unique design of this longer lever takes into consideration the bending and torsional stresses along its vertical and horizontal planes. At some point (ref. Series b,c) along the lever a linkage bar connecting the rear drive crank to the lever is attached, to transmit force exerted on the forward pedal to the drive crank.

With (ref. Series b) the lever arm that drives the crank is positioned at about the same level with the fulcrum. The connecting rod linking the sprocket and lever arm is almost at vertical position located between the fulcrum and the pedals. This connecting rod is also attached to the crank arm with bearings at both points of connection to allow the cyclic motion of the crank arm and sprocket.

A pair of bar supports the rear drive crank located above the rear wheel. The crank drives the chain to the rear wheel sprockets to complete the force-motion drive cycle. With the increased leverage the added force generated, it could translate to increased power and speed. The rider can also maintain moderate speeds at greatly reduced effort as compared to required effort for present ordinary bicycles at comparable speeds.

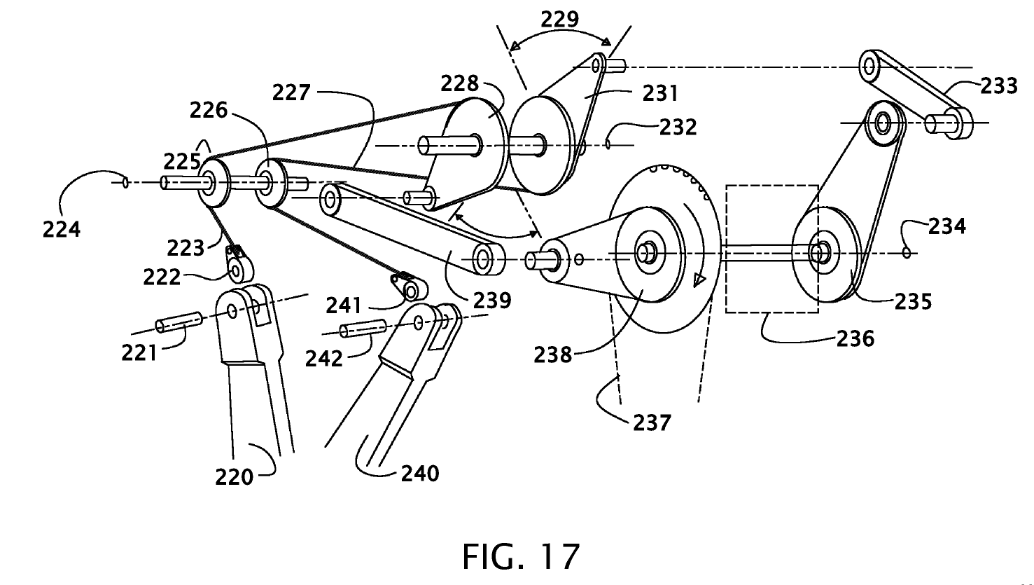

FIG. 17 shows a complementary motion force multiplier exploded view of a force multiplier design. In this figure the right side pedal arm 220 connects to a clevis 222 with a pin 221. A right side steel wire cable 223 connects to the clevis 222. The steel wire cable 223 wraps over the right side pulley 225. The right side steel wire cable 223 also connects to a right pulley arm 228.

The left side pedal arm 240 connects to a clevis 241 with a pin 242. A left side steel wire cable 227 connects to the clevis 241. The left steel wire cable 227 wraps over the left side pulley 226. The left side steel wire cable 227 also connects to a left pulley arm 231. The right pulley arm 228 and the left pulley arm 231 operate on a center rod to supports 232.

A right connecting arm 239 is shown connecting to a right ratchet crank 238. A complimentary left connecting rod 233 and a complimentary left ratchet crank 235 is located on the opposite. A crank and sprocket 234 connect the left and right ratchet cranks to drive a chain to the wheels 237. The area 236 is a sprocket and crank assembly with a slack compensator.

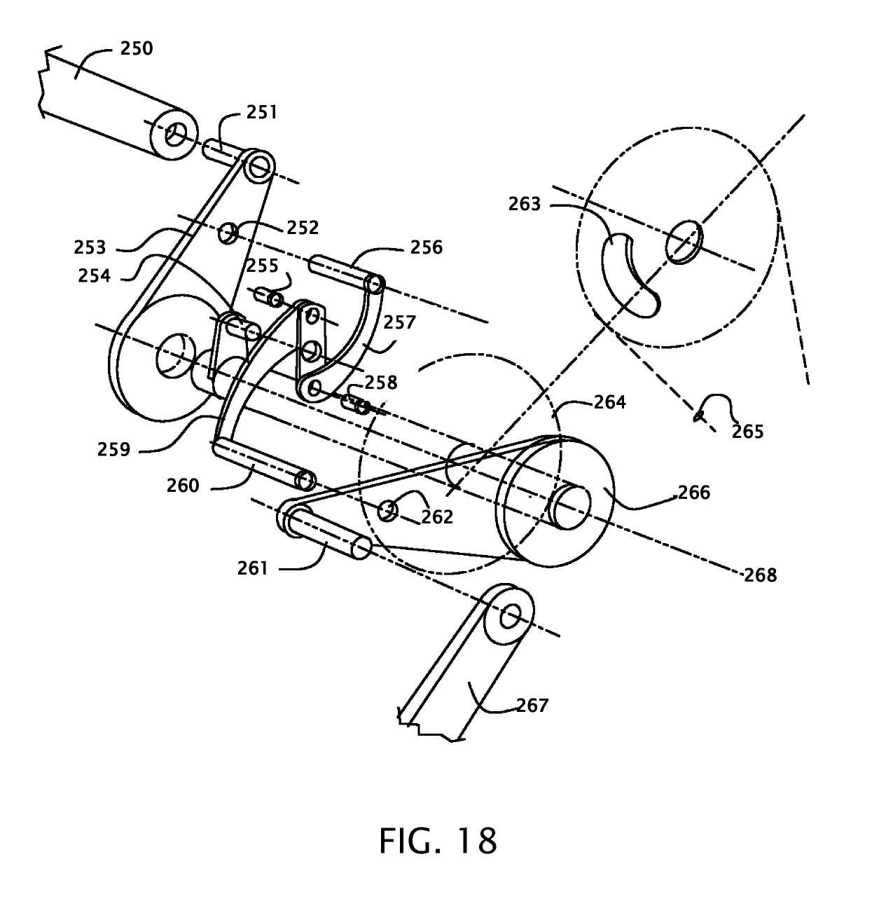

FIG. 18 shows a sprocket and ratchet crank assembly with slack compensator drawing for the force multiplier design. A left connecting rod 250 connects to a left connecting stud 251. The connecting stud 251 is secured to a left ratchet crank 253. A hole 252 retains a connecting rod 256 connected to a compensator arm 257. Connecting pins 255 and 258 allow compensator arm 257 and compensator arm 259. King pin 254 is connected to the main shaft 268. On the opposite side of the bicycle a complementary right connecting rod 267 connects to a right connecting stud 261 connects to connecting rod 260 through hole 262. Right ratchet crank 266 and left ratchet crank 253 are joined to the sprocket 264. A slotted arc hole 263 provides clearance as the cranks rotate from a start to an end position. A sprocket chain 265 connects to other drive components to drive the bicycle wheel(s).

Thus, specific embodiments of a bicycle with front and rear drives with repositioned cranks, extended pedal levers drive have been disclosed. It should be apparent, however, to those skilled in the art that many more modifications besides those described are possible without departing from the inventive concepts herein. The inventive subject matter, therefore, is not to be restricted except in the spirit of the appended claims.

1. A bicycle with front and rear drives with repositioned cranks, extended pedal levers and drive comprising:
an arm-powered front wheel drive to propel a bicycle;
a rear wheel drive system having lever arms to turn rear wheels of said bicycle;
a front wheel drive that is steerable;
said front wheel drive provides physical exercise with a use of upper and lower arm muscles;
said bicycle has provides power generated by lever arms that are translated to move said bicycle using both pushing or pulling on said lever arms.

2. The bicycle according to claim 1 further uses a force multiplier from said lever arms to increase power to propel said bicycle.

3. The bicycle according to claim 1 wherein said front wheel drive propels said bicycle without using said rear wheel drive system.

4. The bicycle according to claim 1 wherein said rear wheel drive propels said bicycle without using said front wheel drive system.

5. The bicycle according to claim 1 wherein both said front wheel drive and said rear wheel drive are both operable simultaneously.

6. The bicycle according to claim 1 further includes a hood and spoilers around a front wheel mechanism.

7. The bicycle according to claim 1 further has front and rear drives with repositioned cranks, extended pedal levers and drive.

8. The bicycle according to claim 7 wherein said repositioned cranks are adjustable to alter leverage on said front wheel drive system.

9. The bicycle according to claim 7 wherein said repositioned cranks are adjustable to alter leverage on said rear wheel drive system.

10. The bicycle according to claim 1 wherein a left and a right rear pedal operate independently.

11. The bicycle according to claim 1 wherein a left and a right front pedal operate independently.

12. The bicycle according to claim 1 wherein a left front pedal drive system is connected to a left rear pedal drive system.

13. The bicycle according to claim 12 wherein said connection between said left front pedal drive system and said left read pedal drive system is with a cable or chain.

14. The bicycle according to claim 1 wherein a right front pedal drive system is connected to a right rear pedal drive system.

15. The bicycle according to claim 14 wherein said connection between said right front pedal drive system and said right read pedal drive system is with a cable or chain.

16. The bicycle according to claim 1 wherein said rear drive lever arms pivot from a point above a bottom of a frame of said bicycle.

17. The bicycle according to claim 2 wherein said force multiplier uses a driver sprocket linked to a driven sprocket.

18. The bicycle according to claim 17 wherein said driver sprocket and said driven sprocket are linked with at least one connecting rod.

19. The bicycle according to claim 18 that further includes a slotted arc hole that provides clearance for a crank that rotates through said slotted arc hole.

20. The bicycle according to claim 17 wherein said driven sprocket is linked to a drive said front wheel or said rear wheel.
